(19) United States
(12) Patent Application Publication
(10) Pub. No.: US 2014/0175116 A1
(43) Pub. Date: Jun. 26, 2014

(54) DISPENSING ASSEMBLY IN VENDING MACHINE

(71) Applicant: HON HAI PRECISION INDUSTRY CO., LTD., New Taipei (TW)

(72) Inventor: YUN-LUNG CHEN, New Taipei (TW)

(73) Assignee: HON HAI PRECISION INDUSTRY CO., LTD., New Taipei (TW)

(21) Appl. No.: 13/953,664

(22) Filed: Jul. 29, 2013

(30) Foreign Application Priority Data
Dec. 20, 2012 (CN) 201210557782X

(51) Int. Cl. G07F 11/50

(52) U.S. Cl. CPC G07F 11/50
USPC 221/277

(57) ABSTRACT

A dispensing device includes a bracket, a base, a tray, a blocking plate, and a jacking member. The tray holds the base to keep a plurality of products on the base. The tray is rotatable to release the base, allowing one item of the products to drop down from the base. The bracket includes a first mounting plate, a first limiting piece extending from the first mounting plate, a second mounting plate, and a second limiting piece extending from the second mounting plate. The first limiting piece defines a first cutout, the second limiting piece defines a second cutout, and the first cutout and the second cutout cooperatively form a receiving hole rotatably receiving the receiving hole therein.

### BACKGROUND

1. Technical Field

The present disclosure relates to vending machines, and particularly to a dispensing assembly in the vending machines.

2. Description of Related Art

In many direct type dispensing devices, a dispensing assembly for dispensing products includes a bracket, a tray, and a shaft. The bracket includes a base for placing the products thereon. The tray is located under the base. The tray is secured to the shaft. The shaft is rotatable under an action of a motor to rotate the tray to hold the base or release the base. When the tray supports the base, the products are blocked by the base and cannot drop down for the customer to pick up. When the tray releases the base, the base is free, causing one item of products to drop down to the customer bin by gravity. Generally, the shaft is inserted in a plurality of shaft sleeves, and then the shaft sleeves are secured to the bracket by screws or latches. However, the securing process of the shaft is time-consuming, and a securing structure of the shaft can be complicated and costly. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a dispensing assembly.

FIG. 2 is an enlarged view of a circled portion II of FIG. 1.

FIG. 3 is an assembled, isometric view of the dispensing assembly of FIG. 1, with a shaft in an initial position.

FIG. 4 is an enlarged view of a circled portion IV of FIG. 3.

FIG. 5 is an similar to FIG. 3, but viewed from a different aspect.

FIG. 6 is another assembled, isometric view of the dispensing assembly of FIG. 1, with the shaft in a first position.

FIG. 7 is similar to FIG. 6, but viewed from a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

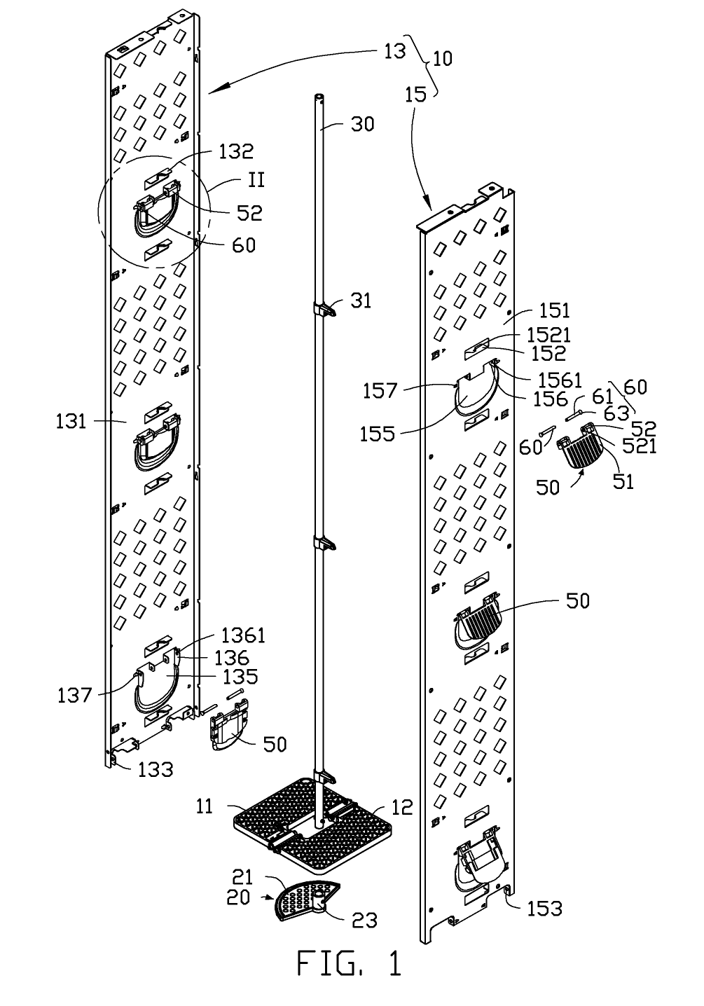

FIG. 1 shows one embodiment of a dispensing device. The dispensing device includes a bracket 10, a first base 11, a second base 12, a tray 20, a shaft 30, and a plurality of blocking plates 50.

The bracket 10 includes a first frame 13 and a second frame 15.

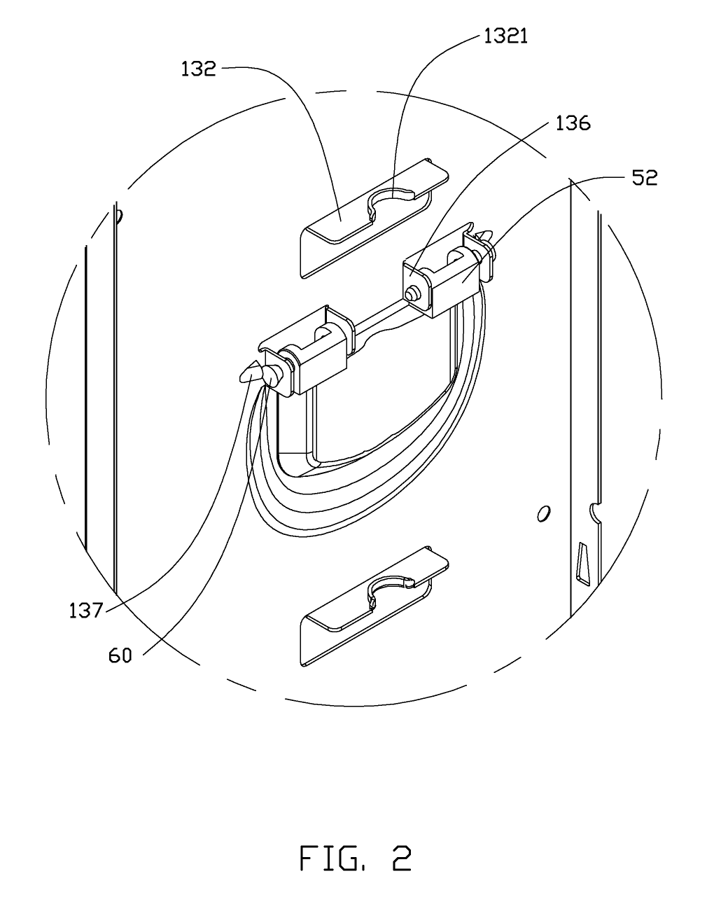

FIG. 1 and FIG. 2 show the first frame 13 including a first mounting plate 131 and a plurality of first limiting pieces 132, extending from a side of the first mounting plate 131. Each first limiting piece 132 defines a first cutout 1321. Two pairs of first pivoting pieces 133 are located at a bottom end of the first mounting plate 131. Each first pivoting piece 133 is substantially perpendicular to the first mounting plate 131. The first mounting plate 131 defines a plurality of first opening 135, and two pairs of first positioning pieces 136 extend from edges of each first opening 135. Each first positioning piece 136 defines a first positioning hole 1361. A first protrusion 137 extends from an outer surface of each first positioning piece 136. The first limiting pieces 132 are integral with the first positioning pieces 136, the first pivoting pieces 133, and the first mounting plate 131. In one embodiment, the first cutout 1321 is semicircular.

The second frame 15 includes a second mounting plate 151 and a plurality of second limiting pieces 152 extending from a side of the second mounting plate 151. Each second limiting piece 152 defines a second cutout 1521. Two pairs of second pivoting pieces 153 are located at a bottom end of the second mounting plate 151. Each second pivoting piece 153 is substantially perpendicular to the second mounting plate 151. The second mounting plate 151 defines a plurality of second opening 155, and two pairs of second positioning pieces 156 extend from edges of each second opening 155. Each second positioning piece 156 defines a second positioning hole 1561. A second protrusion 157 extends from an outer surface of each second positioning piece 156. The second limiting pieces 152 are integral with the second positioning pieces 156, the second pivoting pieces 153, and the second mounting plate 151. In one embodiment, the second cutout 1521 is semicircular.

The tray 20 includes a support plate 21 and a mounting post 23 located on the support plate 21. In one embodiment, the support plate 21 is a section of a circle with an interior angle smaller than 180 degrees, that is, less than a full semicircle.

The shaft 30 secures a plurality of jacking members 31. Each jacking member 31 extends along a direction substantially perpendicular to an axial direction of the shaft 30.

Each blocking plate 50 includes a plate body 51 and two positioning portions 52 extending from an end of the plate body 51. Each positioning portion 52 defines a through hole 521.

The dispensing device further includes a plurality of bolts 60. Each bolt 60 includes an inserting portion 61 and a blocking portion 63. In one embodiment, a cross section of the blocking portion 63 is circular, and the through hole 521 is circular. A diameter of the blocking portion 63 is smaller than a diameter of the through hole 521.

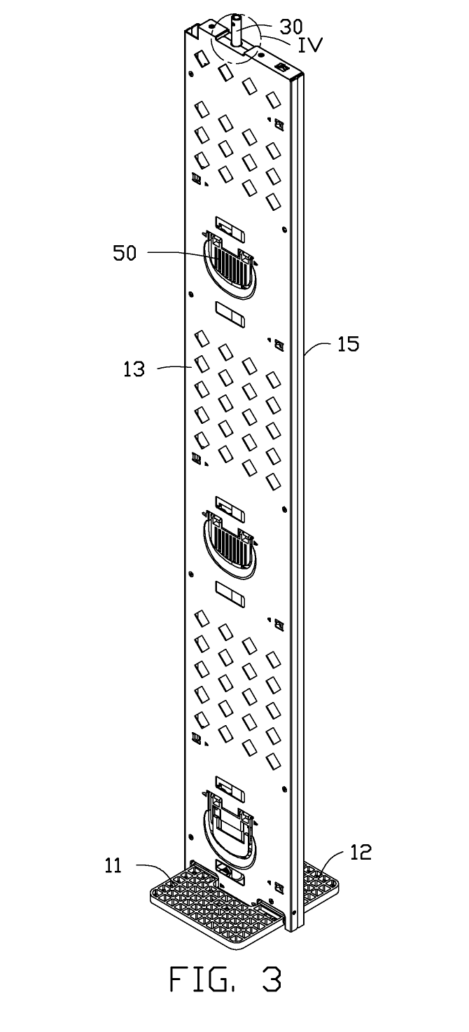

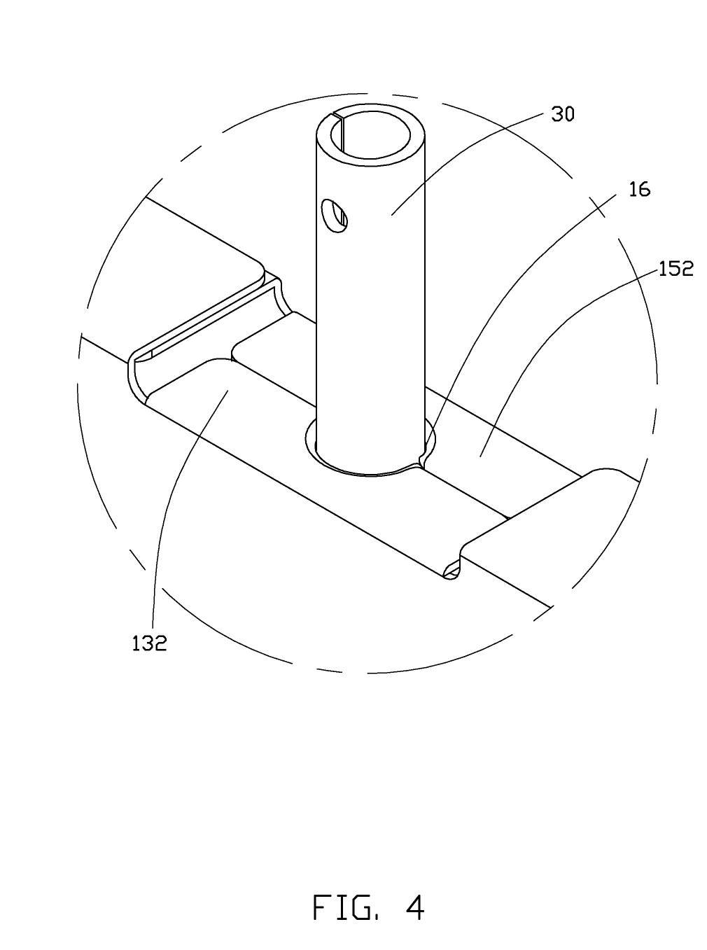

FIG. 2 and FIG. 3 show that in assembly of the blocking plate 50 to the first mounting plate 131, the blocking plate 50 is placed in the first opening 135, and the positioning portion 52 is located in the pair of the first positioning pieces 136. The inserting portion 61 is inserted through the first positioning hole 1361 and the through hole 521 until the blocking portion 63 is blocked by the first protrusion 137. The bolt 60 is slid to elastically deform the first mounting plate 131, causing the blocking portion 63 slide over the first protrusion 137 and the bolt 60 is mounted between the first protrusion 137 and the first positioning piece 136. The first protrusion 137 prevents the bolt 60 from disengaging from the first positioning piece 136. The blocking plate 50 is mounted to the second mounting plate 151 with the same process, in the first mounting plate 131. The first base 11 is rotatably mounted to the first pivoting piece 133. The second base 12 is rotatably mounted to the second pivoting piece 153. The shaft 30 is placed between the first frame 13 and the second frame 15 and aligned with the first cutout 1321 and the second cutout 1521. The first frame 13 is secured to the second frame 15 by screws (not shown). The first cutout 1321 and the second cutout 1521 form a circular receiving hole 16 (shown in FIG. 4) receiving the shaft 30 thereon. The shaft 30 is connected to a motor (not shown), which rotates the shaft 30. Tray 20 is located under the first base 11 and the second base 12. The mounting post 23 surrounds a bottom end of the shaft 30 and is rotatable together with the shaft 30.

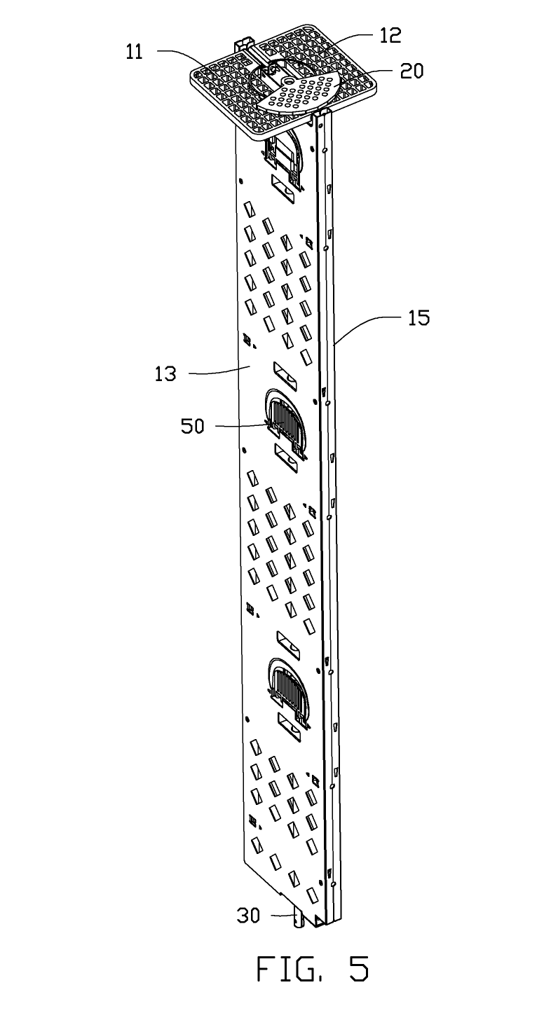

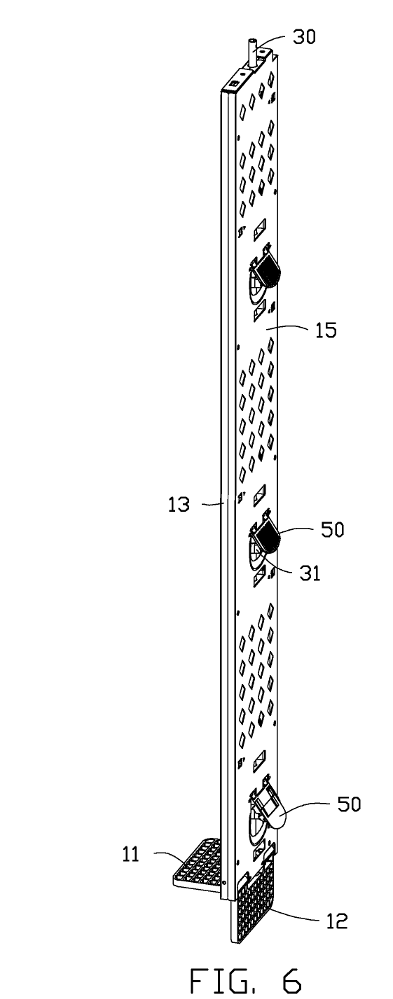

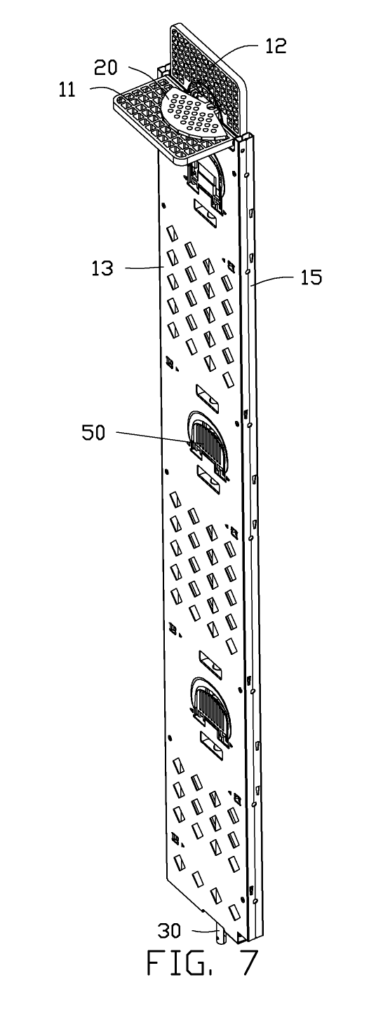

FIGS. 5-7 show that, in use, a plurality of products (not shown) is placed one-by-one, on the first base 11 and on the second base 12. The shaft 30 is rotatable between an initial position and a first position. The shaft 30 is further rotatable between the initial position and a second position. When the shaft 30 is in the initial position, the jacking members 31 is between the first mounting plate 131 and the second mounting plate 151, the plate body 51 is received in the first opening 135 or the second opening 155, and the tray 20 holds the first base 11 and the second base 12, preventing the first base 11 and the second base 12 from rotating relative to the first frame 13 and a second frame 15. Thus, before a purchase is made, an item of products cannot be dropped down from the first base 11 and the second base 12.

When the shaft 30 is in the first position, the tray 20 is rotated over the second base 12 and holds the first base 11 in place. At the same time, the jacking member 31 extends out of the first opening 135 and jacks the blocking plates 50 from the first mounting plate 131. In this position, the products on the second base 12 are rotatable relative to the shaft 30 under the action of gravity and may drop down to the second base 12 if one item of the products is purchased. The blocking plate 50 extends out of the first opening 135 to hold and keep the unpurchased products 100 on the second base 12.

When the shaft 30 is in the second position, the tray 20 is rotated over the first base 11 and holds the second base 12. At the same time, the jacking member 31 extends out of the second opening 155 and jacks the blocking plates 50 from the second mounting plate 151. In this position, the products on the first base 11 are rotatable relative to the shaft 30 under the action of gravity to drop down from the first base 11, if one item of products is purchased. The blocking plate 50 extends out of the second opening 155 to hold the remaining unpurchased products 100 on the first base 11.

When the products 100 are in place but unpurchased, the shaft 30 is in the initial position. When one of the products 100 is purchased, the motor drives the shaft 30 to rotate to the first position or to the second position, allowing one item of the products 100 to drop down from the first base 11 or from the second base 12. Then the motor drives the shaft 30 to rotate to the initial position, causing the tray 20 to rotate the first base 11 or the second base 12 upwards, until the tray 20 holds the first base 11 and the second base 12. The unpurchased products 100 remain and are thus prevented from dropping down.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A dispensing assembly, comprising:
a bracket comprising a first mounting plate; a first limiting piece, extending from the first mounting plate; a second mounting plate; and a second limiting piece, extending from the second mounting plate;
a base rotatably mounted to the bracket;
a shaft rotatably received in the bracket;
a tray secured to the shaft and holding the base;
wherein the shaft is rotatable relative to the bracket, when the shaft is rotated relative to the bracket, the tray is released and rotatable relative to the bracket, which configured for allowing a product to drop down the base due to gravity; the first mounting plate is secured to the second mounting plate; the first limiting piece defines a first cutout, the second limiting piece defines a second cutout, and the first cutout and the second cutout cooperatively form a receiving hole; and the shaft is rotatably received in the receiving hole.

2. The dispensing assembly of claim 1, wherein the first limiting piece is integrated with the first mounting plate, and the second limiting piece is integrated with the second mounting plate.

3. The dispensing assembly of claim 1, wherein each of the first cutout and the second cutout is semicircular.

4. The dispensing assembly of claim 1, further comprises a blocking plate rotatably mounted to the bracket and a jacking member secured to the shaft, wherein the shaft is rotatable to extend the jacking member out of the bracket, and the jacking member jacks the blocking plate, which is configured for holding remained products on the base.

5. The dispensing assembly of claim 4, wherein an extending direction of the jacking member is substantially perpendicular to the shaft.

6. The dispensing assembly of claim 4, further comprising a bolt, wherein the bracket comprises a pair of positioning pieces extending from the first mounting plate; the blocking plate comprises a positioning portion; and the positioning portion is rotatably mounted between the pair of positioning pieces by the bolt, and the pair of positioning pieces are integrated with the first mounting plate.

7. The dispensing assembly of claim 6, wherein each positioning piece defines a positioning hole, and the positioning portion defines a through hole; the bolt comprises an inserting portion and a blocking portion; the inserting portion extends out of the positioning hole and the through hole; and the blocking portion is located outside of the pair of positioning pieces.

8. The dispensing assembly of claim 7, wherein the bracket further comprises a protrusion extending from the first mounting plate, and the blocking portion is engaged between the protrusion and the pair of positioning pieces, preventing the bolt from sliding out of the pair of positioning pieces.

9. The dispensing assembly of claim 6, wherein the blocking plate is rotatable relative to the first mounting plate about the bolt, and the bolt is substantially perpendicular to the shaft.

10. The dispensing assembly of claim 4, wherein the bracket defines an opening, and the blocking plate is received in the opening and is substantially parallel to the first mounting plate; and the shaft is rotatable to extend the jacking member out of the opening, to jack the blocking plate out of the opening.

11. A dispensing assembly, comprising:
a bracket comprising a first mounting plate; a first limiting piece, extending from the first mounting plate; a second mounting plate; and a second limiting piece, extending from the second mounting plate;
a base rotatably mounted to the bracket;
a shaft rotatably received in the bracket;
a tray secured to the shaft and for holding the base;
a blocking plate rotatably mounted to the bracket; and
a jacking member secured to the shaft;
wherein the shaft is rotatable between an initial position and a first position; when the shaft is in the initial position, the jacking member is inside of the bracket, and the tray holds the base, preventing the base from being rotated relative to the bracket; and when the shaft is in the first position, the tray releases the base, the base is rotatable relative to the bracket, which configured for allowing a product to drop down the base due to gravity, and the jacking member extends out of the bracket to rotate the blocking plate, which configured for holding remained products on the base; the first mounting plate is secured to the second mounting plate; the first limiting piece defines a first cutout, the second limiting piece defines a second cutout, and the first cutout and the second cutout cooperatively form a receiving hole; and the shaft is rotatably received in the receiving hole.

12. The dispensing assembly of claim 11, wherein the first limiting piece is integrated with the first mounting plate, and the second limiting piece is integrated with the second mounting plate.

13. The dispensing assembly of claim 11, wherein each of the first cutout and the second cutout is semicircular.

14. The dispensing assembly of claim 11, wherein when the shaft is in the initial position, the jacking member is substantially parallel to the first mounting plate, and when the shaft is in the first position, the jacking member is substantially perpendicular to the first mounting plate.

15. The dispensing assembly of claim 11, wherein an extending direction of the jacking member is substantially perpendicular to the shaft.

16. The dispensing assembly of claim 11, further comprising a bolt, wherein the bracket comprises a pair of positioning pieces extending from the first mounting plate; the blocking plate comprises a positioning portion; and the positioning portion is rotatably mounted between the pair of positioning pieces by the bolt, and the pair of positioning pieces are integrated with the first mounting plate.

17. The dispensing assembly of claim 16, wherein each positioning piece defines a positioning hole, and the positing portion defines a through hole; the bolt comprises an inserting portion and a blocking portion; the inserting portion extends out of the positioning hole and the through hole; and the blocking portion is located outside of the pair of positioning pieces.

18. The dispensing assembly of claim 17, wherein the bracket further comprises a protrusion extending from the first mounting plate, and the blocking portion is engaged between the protrusion and the pair of positioning pieces, preventing the bolt from sliding out of the pair of positioning pieces.

19. The dispensing assembly of claim 16, wherein the blocking plate is rotatable relative to the first mounting plate about the bolt, and the bolt is substantially perpendicular to the shaft.

20. The dispensing assembly of claim 11, wherein the bracket defines an opening, when the shaft is in the initial position, the blocking plate is received in the opening, and when the shaft is in the first position, the jacking member extends out of the opening and jacks the blocking plate out of the opening.
